(19) United States
(12) Patent Application Publication
(10) Pub. No.: US 2002/0091729 A1
(43) Pub. Date: Jul. 11, 2002

(54) Method for accomplishing tabular frame object

(75) Inventors: Fan Gang, Tien-Chin City (CN); Tong S. Chen, Taipei (TW); Kuang-Shin Lin, Taipei (TW)

Correspondence Address: LOWE HAUPTMAN GILMAN & BERNER, LLP, Suite 310, 1700 Diagonal Road, Alexandria, VA, 22314, US

(73) Assignee: INVENTEC CORPORATION

(21) Appl. No.: 09/754,292

(22) Filed: Jan. 5, 2001

(51) Int. Cl. G06F 7/00

(52) U.S. Cl. 707/503

(57) ABSTRACT

A method for accomplishing tabular frame object, at least includes following steps: reads a table range of a tabular frame; connects to a database whose range is larger than range of the table range; reads a title row and at least a data record from the database, where the data records are corresponding to the table range; shows the title row and these data records; reads a moving distance of a moving indicator of the tabular frame; calculates a new location of the tabular frame in the database in accordance with the moving distance, then finds at least a new corresponding data record that locates in the new location; and shows the title line and the new corresponding data records. In addition, the method uses Script program so application of the method is independent on variety of browser.

### BACKGROUND OF THE INVENTION

1. Field of the Invention

The invnetion relates to method for dynamic showing both title and contents of a tabular frame in accordance with moving of corresponding moving indicator, and also relates to methods for supporting dynamic bonding data and for operating without limitation of variety of browser.

2. Description of the Prior Art

Table and tabular frame of current technology, particularly technology of web page, always exist some disadvantages. For tabular frame, as usual only one row is used and then it is impossible to accomplish multi-columns function, then user can not refer to several kinds data and compare different data at the same time. For table, as shown in FIG. 1A and FIG. 1B, though table can accomplish multi-columns function, because contents 11 in the table is changed as table is moved in accordance with moving indicator 13 of moving column 12, whenever number of referred data records is larger than showing account of the table and moving distance of moving indicator 13 is too larger to be shown, only several data records are showed in table but title row 14 is disappeared, and then user's convenience will be decreased. Further, tabular frame accomplished by current technology, particularly technology of web page, not only can not dynamic bind data but also can not dynamic renew contents of tabular frame.

Besides, for current technology of web page, tabular frame object usually is constructed by Active X program. Whereby, advantages at least includes interactive interface and ability of downloading data from internet, but a serious disadvantage is that some browsers, such as Netscape communication, do not support Active X program and then application of tabular frame is limited by variety of browser. Thus, tabular frame must be developed and constructed for different browsers and then cost is increased and operation also is complicated. Further, tabular frame constructed by Active X also is in the soup of safety leak.

According to previous discussion, it is natural that current tabular frame is mendable, particularly when used by web page, and then it is desired to develop new tabular frame.

### SUMMARY OF THE INVENTION

A main object of the present invention is to provide method for accomplishing multi-columns function of tabular columns and effectively controlling. The multi-columns function only can simultaneously show contents of several columns as current table but also can accomplish a multi-selection and single-selection control.

Another object of the present invention is to provide a method that not only dynamic binds data but also dynamic renews contents of tabular frame.

Still an object of the present invention is to provide a method for applying tabular frame in web page without limitation of variety of browsers and also without repeated development.

One preferred embodiment of the invnetion is a method for accomplishing tabular frame object, at least includes following steps: reads a table range of a tabular frame; connects to a database whose range is larger than range of the table range; reads a title row and at least a data record from the database, where the data records are corresponding to the table range; shows the title row and these data records; reads a moving distance of a moving indicator of the tabular frame; calculates a new location of the tabular frame in the database in accordance with the moving distance, then finds at least a new corresponding data record that locates in the new location; and shows the title line and the new corresponding data record.

Another preferred embodiment of the invention is a method for accomplishing tabular frame object in a web page without limitation of browser, at least includes following steps: reads both scale of an outer part of a tabular frame and scale of an inner part of the tabular frame, then sets up an overflow attribution of the outer part is auto whenever scale of the inner part excesses scale of the outer part, otherwise decides relation between the outer part and the inner part in according to a data base to let showed contents do not excess region of the tabular frame and to active a moving characteristic; establishes a title row of the tabular frame in accordance with at least a title element of a inner table that inside the inner part; accomplishes a multi-selection and single-selection control in accordance with an impose condition of a user; and sequentially acquires information of at lease a column of the tabular frame from the database when a database complete message is received.

### BRIEF DESCRIPTION OF THE DRAWINGS

The above objects, and other features and advantages of the present invention will become apparent after a reading of the following detailed description taken in conjunction with the drawings, in which:

FIG. 1A and FIG. 1B are sketch maps about a disadvantage of tabular frame of well-known technology;

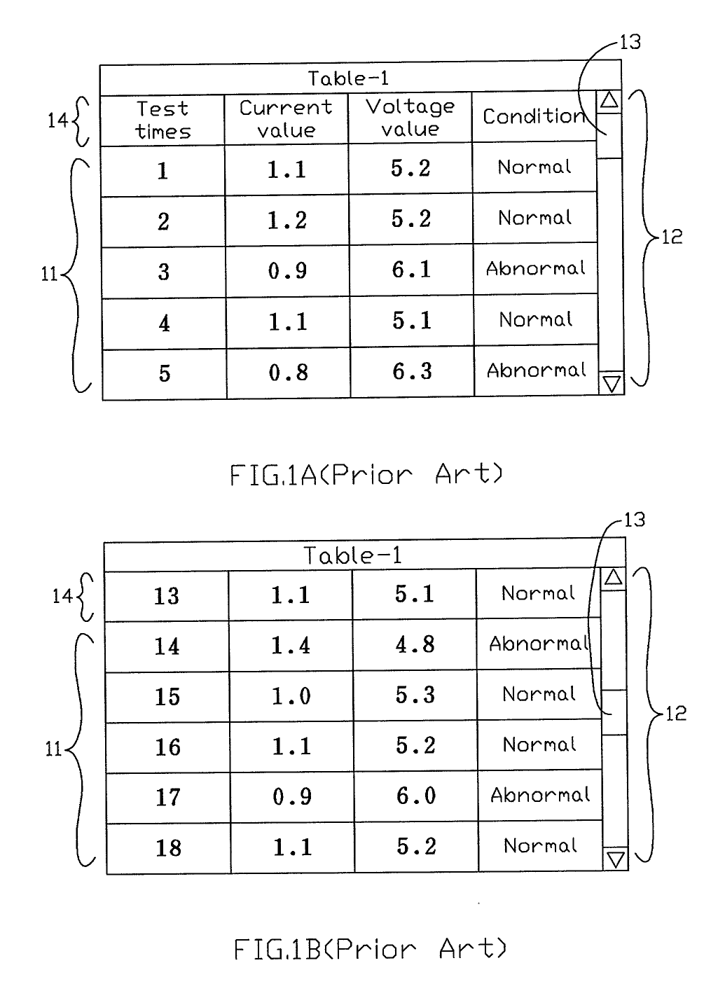

FIG. 2A and FIG. 2B are sketch maps about how disadvantage shown in FIG. 1A and FIG. 1B are eliminated by one preferred embodiment of the invnetion;

FIG. 2C and FIG. 2D are sketch maps about results of one preferred embodiment of the invnetion;

FIG. 3 is a flow-chart of another preferred embodiment to f the invention; and

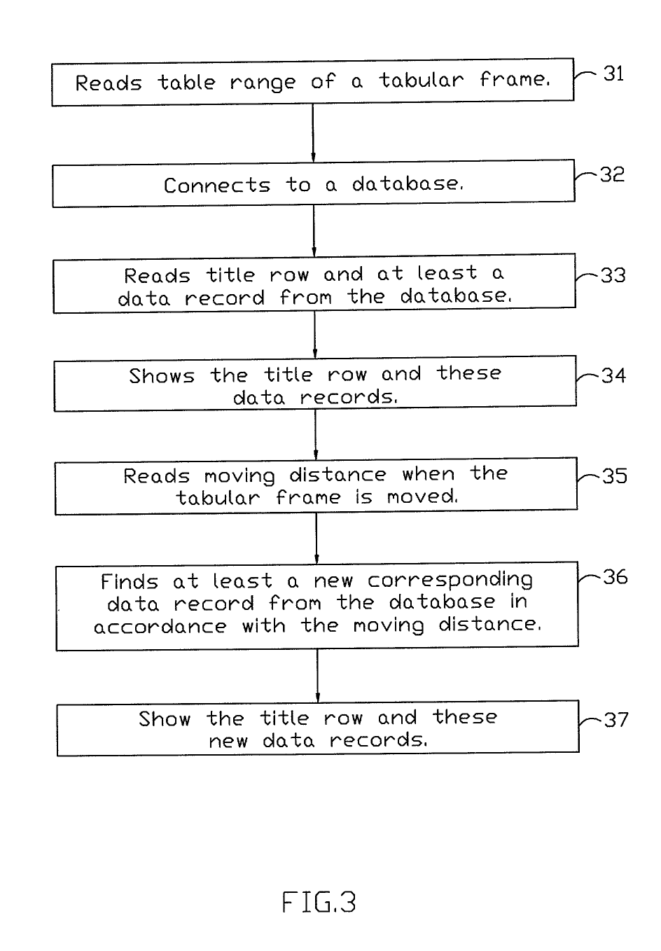

FIG. 4 is a flow-chart of the other preferred embodiment to f the invention.

### DESCRIPTION OF THE PREFERRED EMBODIMENT

First of all, inventors of the invention point out that disadvantage of well-know technology that title row of table will be disappeared as table is moved too far is induced by the reason that title row and columns for showing contents of data are processed together. Then, when table is moved too far, only columns for showing contents is appeared but title row is disappeared.

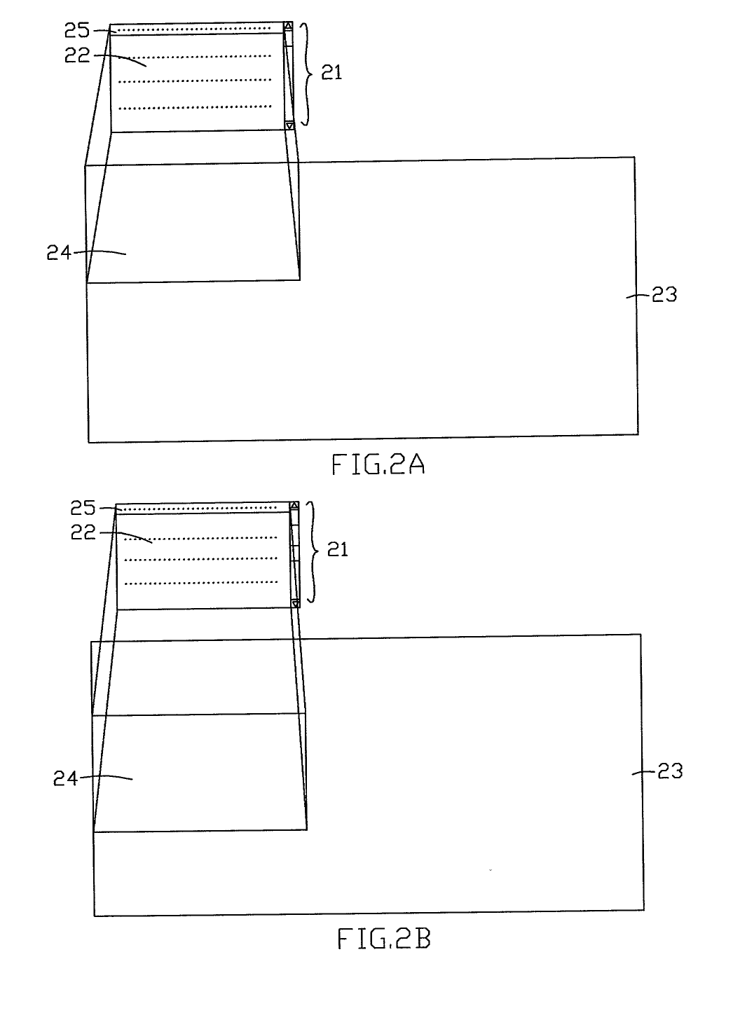

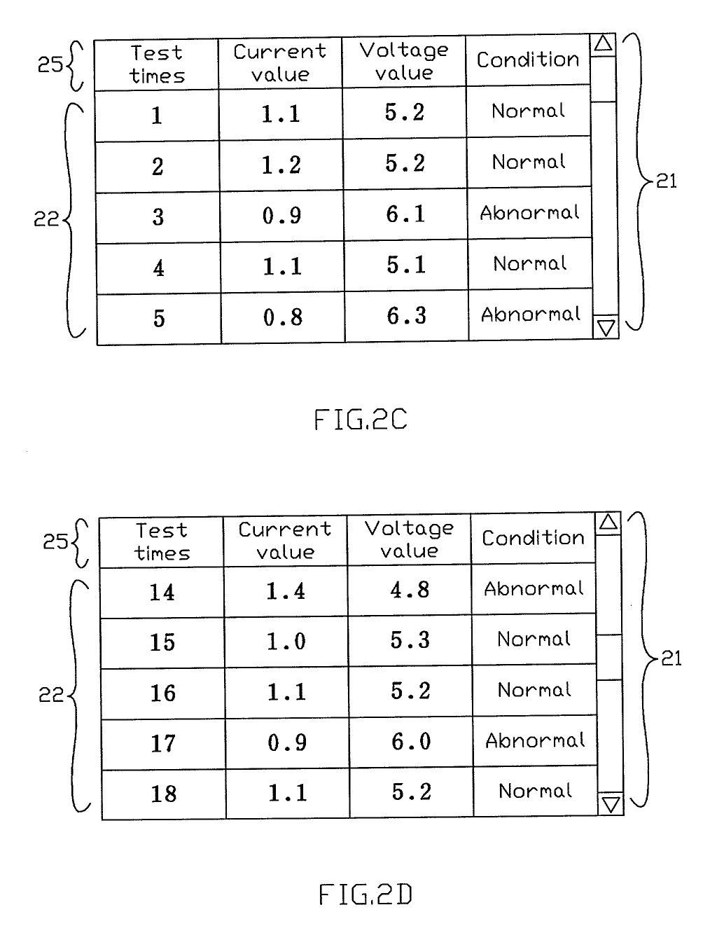

Therefore, first embodiment of the invention is a method for accomplishing tabular frame object, where title row and columns for showing contents are processed separately. As shown in both FIG. 2A and FIG. 2B, movement of tabular frame 21 only change contents corresponding data range 23 of columns 22 in database 23, title row 25 is not changed as tabular frame is corresponding to different parts of database 23 and always is immovable. As shown in both FIG. 2C and FIG. 2D, title row 25 always is presentational and is independent on neither moving state nor corresponding data of tabular 21.

As FIG. 2 shows, the method at least includes following basic steps: as limitation block 31 shows, reads a table range of a tabular frame; as data block 32 shows, connects to a database whose range is larger than range of the table range; as input block 33 shows, reads a title row and at least a data record from the database, where the data records are corresponding to the table range; as display block 34 shows, shows the title row and these data records; as move block 35 shows, reads a moving distance of a moving indicator of the tabular frame; as calculation block 36 shows, calculates a new location of the tabular frame in the database in accordance with the moving distance, then finds at least a new corresponding data record that locates in the new location; and as renew block 37 shows, shows the title line and the new corresponding data record.

Surely, the method further comprises a style defining process for defining external style of the tabular frame, such as character pattern, color of tabular frame and existence of wood grain. The method also further comprises application of a Script program for binding data of database to let application of tabular frame is not limited by variety of browser when tabular frame is used in web page, where Script program can be performed without compilation.

Besides, when tabular frame is used in web page, table range is coordinate of said tabular frame in a hypertext markup language. Further, tabular at least includes a column, and further comprises at least a special column of columns for accomplishing tabular frame object when more than one column is included.

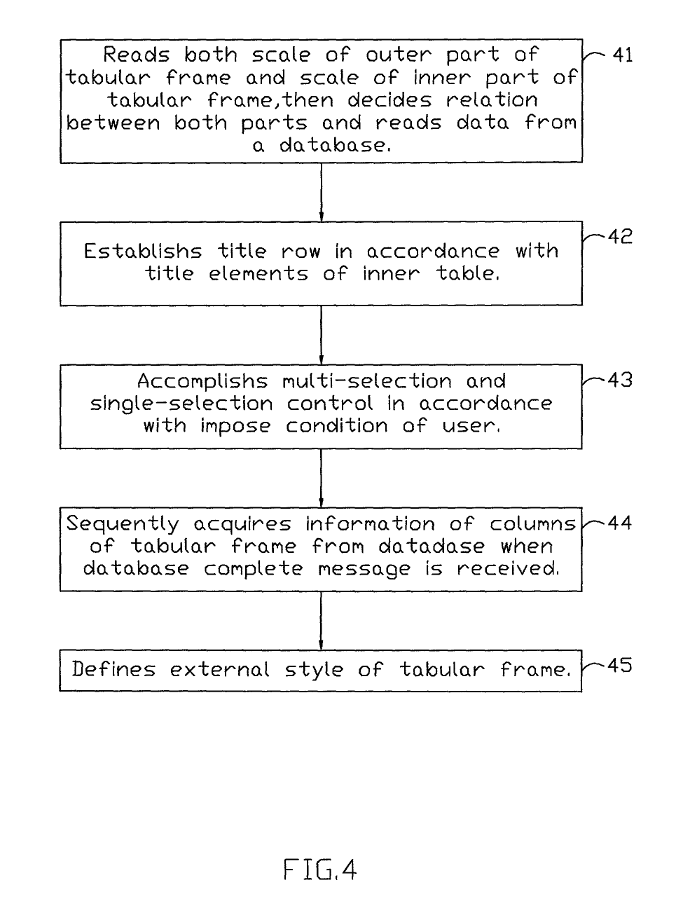

Another preferred embodiment is related to a method for accomplishing tabular frame object in a web page without limitation of browser, and is important application of tabular frame in web page. As FIG. 4 shows, the method at least includes following basic steps:

As flow control block 41 shows, reads both scale of an outer part of a tabular frame and scale of an inner part of the tabular frame, then sets up an overflow attribution of the outer part is auto whenever scale of the inner part excesses scale of the outer part, otherwise decides relation between the outer part and the inner part in according to a data base to let showed contents do not excess region of the tabular frame and to active a moving characteristic. Herein, outer range is coordinate, such as height and width, of the tabular frame in a hypertext markup language, and the tabular frame not only usually comprises a plurality of columns but also usually is regarded as an equivalent table for simulating multi-columns function of a table.

As title control block 42 shows, establishes a title row of the tabular frame in accordance with at least a title element of an inner table that inside the inner part.

As selection control block 43 shows, accomplishes a multi-selection and single-selection control in accordance with an impose condition of a user.

As binding data block 44 shows, sequentially acquires information of at lease a column of the tabular frame from the database when a database complete message is received.

Surely, the method further comprises a style defining process for defining external style of the tabular frame, such as character pattern, color of tabular frame and existence of wood grain, as style definition block 45 shows.

Besides, it should be emphasized that the method use a Script program for binding data of database and then application of tabular frame is not limited by variety of browser, which is a serious disadvantage when tabular frame is constructed by Active X language.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A method for accomplishing tabular frame object, comprising:
reading a table range of a tabular frame;
connecting to a database, wherein range of said database is larger than range of said table range;
reading a title row and at least a data record from said database, wherein said data records are corresponding to said table range;
showing said title row and said data records;
reading a moving distance of a moving indicator of said tabular frame;
calculating a new location of said tabular frame in said database in accordance with said moving distance, finding at least a new corresponding data record that locates in said new location; and
showing said title line and said new corresponding data records.

2. The method according to claim 1, wherein said tabular frame is used in a web page.

3. The method according to claim 1, wherein said table range is coordinate of said tabular frame in a hypertext markup language.

4. The method according to claim 1, wherein said tabular frame comprises a column.

5. The method according to claim 4, further comprising at least a special column of said columns for accomplishing said tabular frame object.

6. The method according to claim 1, further comprising application of a Script program for binding data of said database.

7. The method according to claim 6, wherein said Script program can be performed without compilation.

8. The method according to claim 1, further comprising a style defining process for defining external style of said tabular frame.

9. A method for accomplishing tabular frame object in a web page without limitation of browser, comprising:
reading both scale of an outer part of a tabular frame and scale of an inner part of said tabular frame, setting up an overflow attribution of said outer part is auto whenever scale of said inner part excesses scale of said outer part, otherwise deciding relation between said outer part and said inner part in according to a data base to let showed contents do not excess region of said tabular frame and to active a moving characteristic;
establishing a title row of said tabular frame in accordance with at least a title element of a inner table that inside said inner part;
accomplishing a multi-selection and single-selection control in accordance with an impose condition of a user; and
sequentially acquiring information of at lease a column of said tabular frame from said database when a database complete message is received.

10. The method according to claim 9, further comprising a style defining process for defining external style of said tabular frame.

11. The method according to claim 9, wherein a Script program is used without requirement of complication.

12. The method according to claim 9, wherein said outer range is coordinate of said tabular frame in a hypertext markup language.

13. The method according to claim 9, wherein said tabular frame comprises a plurality of columns.

14. The method according to claim 13, wherein said tabular frame is regarded as an equivalent table for simulating multi-columns function of a table.
